(19) United States
(12) Patent Application Publication
(10) Pub. No.: US 2006/0235654 A1
(43) Pub. Date: Oct. 19, 2006

(54) Apparatus and method for adaptive data transmission

(76) Inventor: Peter Parnes, LULEA (SE)

Correspondence Address: YOUNG & THOMPSON, 745 SOUTH 23RD STREET, 2ND FLOOR, ARLINGTON, VA, 22202, US

(21) Appl. No.: 10/508,868

(22) PCT Filed: Mar. 24, 2003
(86) PCT No.: PCT/SE03/00485

§ 371 Date: Jul. 11, 2005

(30) Foreign Application Priority Data
Mar. 26, 2002 (SE) 0200926-4

(51) Int. Cl. G06F 15/00

(52) U.S. Cl. 702/186

(57) ABSTRACT

An apparatus and method for adjusting bandwidth utilisation between a group of different participating users accessing client terminals in a common media event in a computer network. The apparatus includes a distributing unit which distributes address information and bandwidth limitation to the users connectable via the computer network to the media event from their respective client terminals. The distributing unit is hosted from a central administration entity and connecting links connect each client terminals of participating users via the Internet or other global interconnecting network to the distributing unit. Measurement elements are provided in association with the client terminals to measure incoming data streams from other users. The distributed bandwidth limitation is provided to the client terminals to allow them to compare incoming data streams, in response to which the terminals autonomously adjust their amount of transmission to a level that allows for optimal utilisation of available resources during transmission.

### TECHNICAL FIELD OF THE INVENTION

The present invention generally relates to an apparatus and method for adapting bandwidth transmission relating to one sender based on the amount of bandwidth used by other senders within a group of senders.

### BACKGROUND OF THE INVENTION

During the last 20 years, and in particular during the last decade, the information obtainable from the Internet has increased immensely. Users of computers and computer controlled equipment have become used to the ability of retrieving all kinds of information at high transmission rates and especially for the younger generation, the Internet now represents the first choice when searching for information. The impact that the Internet will have on everyone's daily life cannot be overestimated, at least in a little longer perspective than a few years.

One of the ever increasing requirements from all users is bandwidth, i.e. provision of a sufficient transmission rate of digital information, the information either being sent or retrieved. Even though the transmission rates to and from ordinary personal computers have increased from a few kbits/second to sometimes far above 2 Mbits/second in just a few years, the limited transmission rates still causes congestion while transmitting in computer networks no matter what their nature is. Congestion is particularly undesirable when broadcasting video and audio streams to media consuming users over the Internet, since the transmission quality must not be above a certain limit in order to allow the desired message to be conveyed to the user. Media services being paid for by users of the service, such as the so called “video on demand” and various tools that enable real time electronic meetings, must come up to the offered standard in order to meet the user expectations and to justify the charged costs by service providers for the service in question.

The international patent application WO 01/77850 discloses a multicast congestion control program that comprises a round trip time estimator estimating the round trip time of the multicast. When the round trip time of the multicast is above a predetermined value, the transmission rate is decreased by half since loss of information is detected.

Known real-time group handling applications in the field use a centralised entity for calculating the transmission rate as data is sent through the entity. A solution without the centralised entity having to calculate transmission rates would be advantageous for simplicity reasons.

Other prior art solutions to the problem of congestion either utilises a fixed sending rate or an adaptation of accessible bandwidth, the adaptation based on feedback from receivers to the sending clients. The later is usually the case in point-to-point communication on the Internet but algorithms applicable are not designed for group communication and are not suitable for use here. Group communication with several active senders at the same time is not yet widely spread and thus applicable solutions to the problem of congestion and limited or varying bandwidth in the field of group communication are still lacking.

Even though the transmission rate is continuously increasing, bandwidth will always be more or less limited as Internet applications as a result of the enhanced abilities of services developed require more bandwidth. In particular Internet based multimedia services require very high transmission rates. From a users point of view it is desirable to keep the total bandwidth used within the communicating group in a certain media event below a certain limit, the limit depending on the transmission capacity of the network used.

### SUMMARY OF THE INVENTION

It is therefore an object of the present invention to alleviate the previously mentioned shortcomings of prior art associated with group communication services. This is accomplished by an apparatus and method for monitoring and adjusting bandwidth utilisation between a group of different participating users accessing client terminals in a common media event in a computer network, the apparatus comprising:
a distributing unit adapted to distribute address information and bandwidth limitation to the participating users connectable via the computer network to the common media event from their respective client terminals, the distributing unit being hosted from a central administration entity,
connecting links adapted to connect each client terminals of participating users via the Internet or any other global interconnecting network to the distributing unit,
measurement means in association with the client terminals adapted to measure incoming data streams from other users, characterised in that
the distributed bandwidth limitation is provided to the client terminals to allow them to compare the incoming data streams therewith, in response to which the client terminals autonomously adjust their amount of transmission to a level that allows for optimal utilisation of available resources during transmission.

By monitoring the amount of bandwidth used for transmission by other senders, for instance transmission of streamed video, every sender, i.e. participating user in front of a client terminal, is instructed by a regulating means to adapt its own transmission rate. This is in order to keep the total amount of bandwidth used under a fixed and predetermined limit. A single user can request more transmission capacity, like for instance video bandwidth, by just sending more and others will lower their transmission rate automatically due to immediate instructions from the regulating means. Every sender will by this also automatically adapt when senders join or leave the group.

The present invention can be used for transmission of general data within a wide range of applications, such as for example a common digital note pad with similar functionality to an ordinary whiteboard, web information and video transmission. The applicability of the present invention ranges as widely as including all kinds of digital information content and conceivable fields for use are all Internet-based services provided, in particular fields involving high transmission rates and large amounts of data to be transmitted.

Preferably, the bandwidth limitation and address information is transmitted electronically in response to a participating user being accepted to enter into a certain media event, but the information can be forwarded to the user in any way. E-mail or accessibility via a secure web-address where the participating user is able to log in are two examples of ways to distribute data necessary for participation.

As long as a transmission capacity allows for a certain rate of transmission without congestion or delays, the sense of security is improved when knowing that this certain rate is sufficient for a particular media service to function properly.

### BRIEF DESCRIPTION OF THE DRAWINGS

The features, objects, and further advantages of this invention will become apparent by reading this description in conjunction with the accompanying drawings, in which like reference numerals refer to like elements and in which:

FIG. 1 illustrates an apparatus for monitoring and adapting bandwidth utilisation between different participating users in accordance with the present invention.

### DETAILED DESCRIPTION

The following description is of the best mode presently contemplated for practising the invention. The description is not to be taken in a limiting sense, but is made merely for the purpose of describing the general principles of the invention. The scope of the invention should be ascertained with reference to the issued claims.

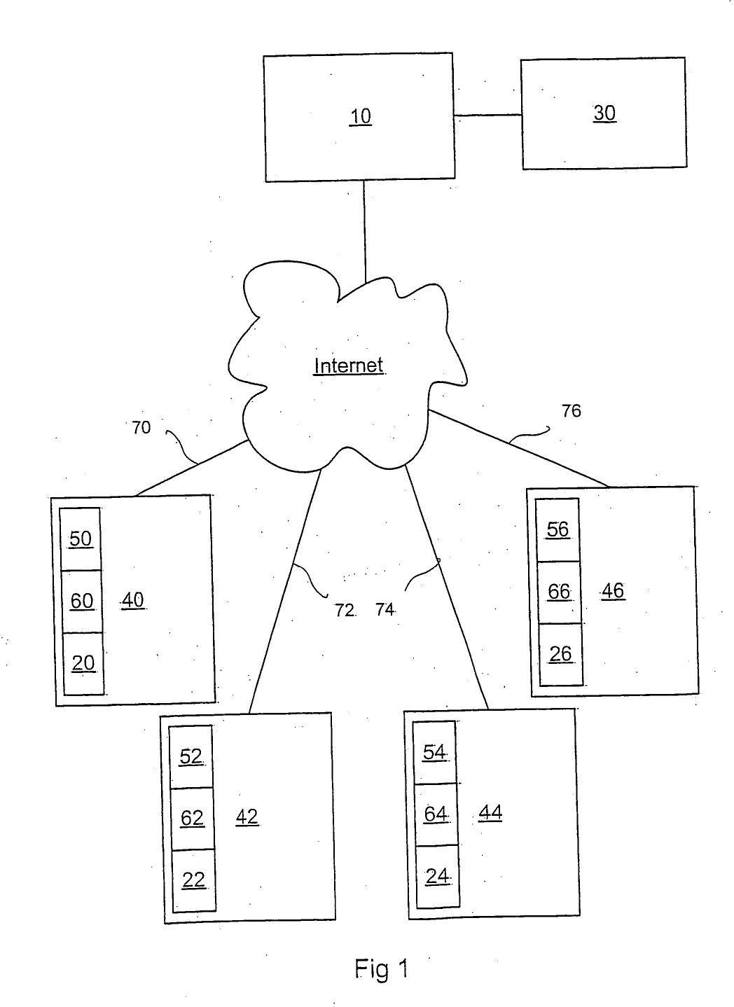

With reference to FIG. 1, the outline of a computer network 5 is illustrated. A plurality of client terminals 40, 42, 44, 46 are connected to the Internet or any other global interconnecting network via connecting links, 70, 72, 74, 76 respectively. Conceivable for use are various wired connections, but likely for use already today or in a near future are also wireless transmission technologies, such as access technology based on infrared, Bluetooth or wireless-LAN. Connection means used in association with the present invention will of course develop with new and emerging access technologies. To each client terminal is coupled an image capturing means 50, 52, 54, 56, preferably a so-called web-camera, a digital camera or a digital video camera. For audio equipped applications must be provided also audio transceiver abilities and signal processing means 60, 62, 64, 66, such as a microphone and loud-speaker arrangement and analogue-digital converters. According to a preferred embodiment a headset is used, but this may not be necessary since most client terminals will be multimedia enabled personal computers having operating audio equipment installed.

Moreover, the Internet or any other network suitable for data transmission is utilised for transporting data between the previously mentioned client terminals and a distributing unit 10. This unit is preferably a portal handling accessibility of users willing to participate in a certain media event. Necessary identification, authentication and authorisation of users is carried out at the distributing unit, but a detailed description of those steps clearly goes beyond the scope of this application and is therefore omitted here.

The distributing unit comprises measurement means 40-46, which are developed to monitor and control the bandwidth utilisation of each of client terminals of the participating users in a media event. The measurement means are preferably provided in software packages necessary for a user who wants to participate in any media event managed, the software is obtainable from the distributing unit. Both the distributing unit and the measurement means are accessible from a central administration entity 30, such as a company running the portal from where the media events are accessible, or by which a so-called electronic meeting with a plurality of participants made possible. Information relating to the bandwidth limitation is suitably to be distributed to users from the distributing unit.

Referring to the apparatus outlined in FIG. 1, an exemplary embodiment of the operation of the present invention will follow. The total bandwidth in a computer network allowing for a certain transmission capacity is set to 500 kbits/s within a group. In other words, the predetermined limitation in total bandwidth use during an interactive media event with a group of participants is 500 kbits/s. The group is about to take active part in an interactive media event, such as for example an electronic meeting. The meeting is established by accessing the group managed by the distributing unit. Accepted participants in the media event, the participants called A and B, both start transmitting data over the computer network at a rate of 400 kbits/s each. By means of the distributing unit and the measurement means with which they communicate, they will be made aware of other participants' transmission and as a result of this information awareness, they will both lower their transmission rates, initially to 100 kbits/s each (500 total minus 400 seen from the third party). The two participants now send at each 100 kbits/s and will be made aware and notice that there is more bandwidth available. Both of them will therefore be instructed to increase their send rate until both are sending at 250 kbits/s each. A third sender C now joins the group and starts sending at a rate 100 kbits/s. Senders A and B will adapt to each sending 200 each. Sender A stops transmission and now sender B will increase its send-rate to 400. Sender C will not do anything as its requested send-rate is already reached (i.e. 100 kbits/s). This process goes on continuously and all senders continuously adapt the transmission rate.

The adaptation to a certain available transmission rate is very quick. In case smoother adaptation is requested the increase or decrease in transmission rate can be lead through a low-pass filter. This smoothens and slows down the adaptation to a lower level which is beneficial in certain situations. During the adaptation process the total transmission rate will sometimes exceed the allowed maximum which in certain cases may cause a problem. This problem is alleviated by means of providing the apparatus with the described low-pass filter.

The present invention makes it possible to adapt the transmission rate in real-time, which is a necessity for being able to add or subtracting participating users during an ongoing media event. The invention is a means for keeping the total bandwidth used within a group of senders at approximately a constant maximum where every sender adapts its transmission rate accordingly.

A simpler way of solving the problem would be to give each potential sender a predefined amount of bandwidth to be used when needed but that would waste bandwidth when not needed. A variant would be that each sender requests a certain transmission rate from a central entity every time needed but that solution doesn't scale as well as the proposal presented here. It also has to rely on a central entity which creates a bottle neck in the system as well as lowers the robustness of the system.

According to an alternative embodiment of the present invention, the senders are invited to negotiate transmission rate. This negotiation is made by utilising rules in a specialised protocol and the senders are intended to agree on which send rate to use. Even though the protocol must be developed in order to realise this embodiment, additional functions and possibilities can be built in the system. The protocol housed by the distributing unit is provided with extra information about the nature of transmission whereby the adaptation does not entirely rely on the real payload data but also on additional information. In some situations, this is an advantageous approach.

1. Apparatus for adjusting bandwidth utilisation between a group of different par-ticipating users accessing client terminals (40-46) in a common media event in a computer network (5), the apparatus comprising:
a distributing unit (10) adapted to distribute address information and bandwidth limitation to the participating users connectable via the computer network to the common media event from their respective client terminals, the distributing unit being hosted from a central administration entity (30),
connecting links (70-76) adapted to connect each client terminals of participating users via the Internet or any other global interconnecting network to the distributing unit,
measurement means (20-26) in association with the client terminals adapted to measure incoming data streams from other users,
characterised in that
the distributed bandwidth limitation is provided to the client terminals to allow them to compare the incoming data streams therewith, in response to which the client terminals autonomously adjust their amount of transmission to a level that allows for optimal utilisation of available resources during transmission.

2. Apparatus for monitoring bandwidth utilisation according to claim 1, characterised in that
the distributing unit is adapted to limit the total use of bandwidth during a media event to a predetermined value, the predetermined value being adaptable and independent of the number of participating users.

3. Apparatus for monitoring bandwidth utilisation according to claim 2, characterised in that
the measurement means of each participating client terminal is adapted to monitor the total incoming data stream, and as a result of a total transmission exceeding the distributed transmission limitation, each client terminal decreases its transmission rate by the exceeded transmission divided by the number of participants.

4. Apparatus for monitoring bandwidth utilisation according to claim 1, characterised in that
the regulation of transmission rate to and from client terminals is adapted by applying a low-pass filter to the transmission rate subjected to adaptation.

5. Apparatus for monitoring bandwidth utilisation according to claim 1, characterised in that
the media event includes transmission of real time video to at least one participating client terminal.

6. Apparatus for monitoring bandwidth utilisation according to claim 1, characterised in that
the media event includes transmission of at least one digital note pad to a plurality of client terminals for mutual interaction between participating users.

7. Apparatus for monitoring bandwidth utilisation according to claim 1, characterised in that
each client terminal is provided with image capturing means (50-56), by which an image of the participating user is captured, the image adapted to be broadcast in real time to other participating users.

8. Apparatus for monitoring bandwidth utilisation according to claim 1, characterised in that
each client terminal is provided with audio capturing means (60-66), by which audio signals of the participating user is captured, the audio signals being digitised and adapted to be broadcast in real time to other participating users.

9. Apparatus for monitoring bandwidth utilisation according to claim 7, characterised in that
the media event includes transmission of a real time images and audio signals of participating users to a plurality of client terminals for mutual interaction between participating users.

10. Apparatus for monitoring bandwidth utilisation according to claim 1, characterised in that
the media event includes transmission of a combination of features including real time video, digital note pad, images and audio signals, the transmission directed to client terminals of participating users.

11. Apparatus for monitoring bandwidth utilisation according to claim 1, characterised in that
connecting links being wireless transmission means, such as infrared, Bluetooth or wireless-LAN.

12. Method for monitoring bandwidth utilisation in a group of users accessing client terminals (40-46) in a common media event in a computer network (5), characterised by the steps of:
by means of a distributing unit (10), distributing to at least one connect-able user address information and a bandwidth limitation,
measuring incoming data streams
comparing the incoming data stream with the distributed bandwidth limitation,
in response to an exceeded bandwidth limitation, regulating the trans-mission rates of a participating client terminals in order to allow for real-time changes of the group structure during the media event.

13. Computer program product for adjusting bandwidth utilisation in group communication, the computer program product being integrated and transmissible between the distributing means (10) and client terminals (40-46) of the apparatus of claim 1.

14. Apparatus for monitoring bandwidth utilisation according to claim 2, characterised in that

15. Apparatus for monitoring bandwidth utilisation according to claim 3, characterised in that

16. Apparatus for monitoring bandwidth utilisation according to claim 8, characterised in that
the media event includes transmission of a real time images and audio signals of participating users to a plurality of client terminals for mutual interaction between participating users.
